(19) United States
(12) Patent Application Publication
(10) Pub. No.: US 2003/0128392 A1
(43) Pub. Date: Jul. 10, 2003

(54) System and method for building standardized print requests

(76) Inventors: Gareth D. O'Brien, Houston, TX (US); Thomas F. Cabanski, Kingwood, TX (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/280,069

(22) Filed: Oct. 25, 2002

Related U.S. Application Data
(60) Provisional application No. 60/347,696, filed on Oct. 26, 2001.

(51) Int. Cl. B41B 1/00; G06F 15/00

(52) U.S. Cl. 358/1.18; 358/1.13

(57) ABSTRACT

A method of converting print jobs from one or more print buyers into standardized print requests. One or more templates are programmed, each template including a plurality of data fields and mapping instructions associated with the data fields. Each data field represents an available print feature for printed materials. The templates are stored on a server coupled to a network and are accessible via remote computers also coupled to the network. Each print buyer is provided access to at least one of the templates through one of the remote computers. The print buyer enters specified information describing the print features of a print job into the data fields of the accessed template. The format of the information entered is converted into a print request having a standardized format using the mapping instructions associated with the accessed template.

### PRIORITY

This application claims priority to U.S. Provisional Application No. 60/347,696, filed on Oct. 25, 2001.

### BACKGROUND OF THE INVENTION

1. Field of the Invention

The field of the present invention is printing.

2. Background

Assembling a good print specification (the terms “print request” and “print specification” are used interchangeably herein) is the first step in obtaining a quote for a print job. Without a good specification, a print buyer is unlikely to get accurate bids from its suppliers. If a job does go to print with a poor print specification, the print buyer is likely to incur significant extra costs to correct any errors.

Print marketplaces and systems implemented to move information between the print buyer and the printer have traditionally solved this problem in one of two ways. The most popular approach is to present the print buyer with a very long questionnaire that is typically full of intimidating print jargon. Further, oftentimes not all of the detailed questions are applicable to the print buyer's particular needs. Unfortunately, when the very novice print buyer is presented with such a detailed questionnaire, that print buyer may very well have difficulty figuring out what the questions mean, much less how to answer them in a meaningful way that will result in the print buyer getting the desired results from a print job.

A second approach that is often taken involves presenting a very simplified questionnaire along with a comment box following each question. The print buyer is usually encouraged to give a plain description of its needs for the print job. Although novice print buyers usually find such an approach easy to use, the approach is often less than satisfactory from the printer's point of view. The problem with this approach arises because the printer's interpretation of the print buyer's plain description in combination with the answers to the questions can be difficult to translate into a meaningful print specification that is useful further downstream in the printing process and one that accurately reflects the print buyer's desired print job.

Once a print buyer's print specification is assembled, difficulties may arise for the print buyer seeking to break the print specification into multiple components, each component to be bid on and performed by different printers. The problem arises because each printer typically receives the entirety of the print specification and not only that portion for which it is to bid on or perform. By sending the entirety of the print specification to each printer, the printers may not bid the correct job or, even worse, may perform the incorrect portion of the print job.

### SUMMARY OF THE INVENTION

The present invention is directed towards a system and method for building standardized print requests. One or more templates are programmed and stored on a server coupled to a network. Each template includes a plurality of data fields and mapping instructions. Each data field represents an available print feature for printed materials. Print buyers may access one or more of the templates on the server via remote computers coupled to the network. When accessing one of the templates, the print buyer is presented with the data fields available in the accessed template. The print buyer then enters specified information into the data fields of the accessed template. The information entered is based upon a print job for which the print buyer desires to obtain a quote for or to order for production. After the print buyer has entered the specified information for the print job, the mapping instructions associated with the accessed template converts the format of the information into a print request having a standardized format.

Further options may be integrated into the present invention. A first option permits the print buyer to leave one or more of the data fields blank in the accessed template. In this instance, the mapping instructions may insert a default value into the standardized print request format as a substitute for the information that was not provided by the print buyer. A second option permits the print buyer to initiate a collaborative process between itself and the printer. Such a collaborative process allows the details of the print specification to be refined by creating a useful dialogue between the print buyer and printer. Yet another option permits the print buyer to place an order for the print job directly through the communications that are established with the printer using such a collaborative system.

Accordingly, it is an object of the present invention to provide a system and method that permit print buyers to submit standardized print requests to printers. Other objects and advantages will appear hereinafter.

### BRIEF DESCRIPTION OF THE DRAWINGS

In the drawings, wherein like reference numerals refer to similar components:

FIG. 1 Is a schematic representation of a system in which print buyers can submit print requests in a standardized format to printers;

FIG. 2 is a flowchart illustrating the work flow enabled by the system of FIG. 1;

FIG. 3 is a flowchart illustrating an alternative work flow enabled by the system of FIG. 1;

FIG. 4 is a screenshot of a template as seen by a print buyer in the standard view;

FIG. 5 is a further screenshot of the template of FIG. 4 as seen by a print buyer in the standard view;

FIG. 6 is a screenshot of the template of FIG. 4 as seen by an administrator in the detailed view;

FIG. 7 is a further screenshot of the template of FIG. 4 as seen by an administrator in the detailed view;

FIG. 8 is a screenshot of a quote from a printer based on the print request as originally submitted by the print buyer;

FIG. 9 is a screenshot of a quote from a printer based upon a print request as modified by the printer;

FIG. 10 is a screenshot illustrating a template being used to select a first set of components of a print job prior to splitting the print job between two or more printers;

FIG. 11 is a screenshot illustrating the template of FIG. 16 being used to send the first set of components of the print job to a first printer;

FIG. 12 is a screenshot illustrating the template of FIG. 16 being used to select a second set of components of the print job prior to splitting the print job between two or more printers;

FIG. 13 is a screenshot illustrating the template of FIG. 16 being used to send the second set of components of the print job to a second printer; and

FIG. 14 is a screenshot illustrating the print request as received by a printer.

### DETAILED DESCRIPTION OF THE PREFERRED EMBODIMENTS

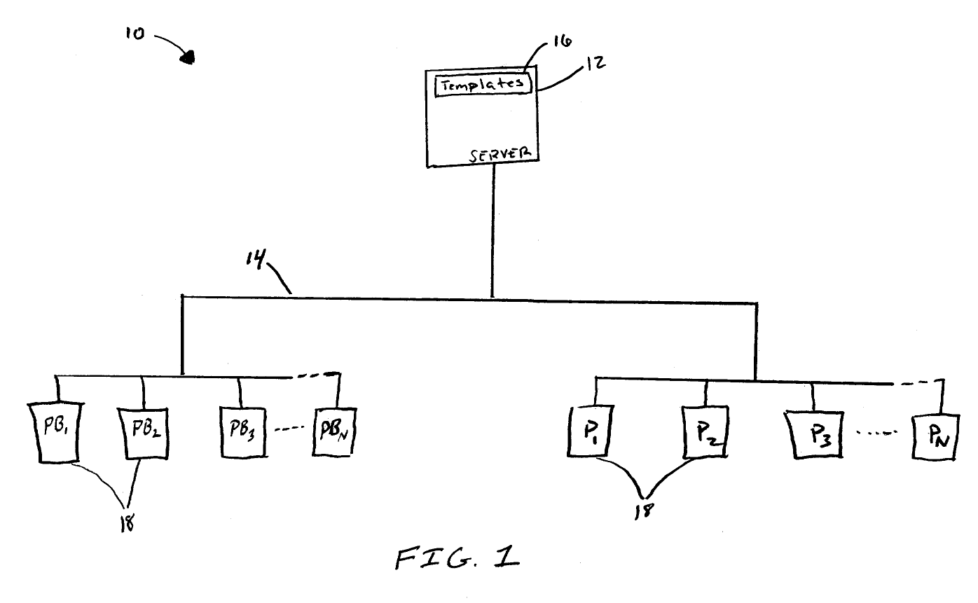

Turning in detail to the drawings, FIG. 1 is a schematic illustration of a system 10 enabling print buyers to submit standardized print requests to any one of a plurality of printers. A server 12 and a plurality of remote computers 18 are coupled to a network 14. The network may be an open infrastructure such as the Internet, or a closed infrastructure such as a WAN, VPN, or the like. The actual structure of the network is unimportant for purposes of the present invention so long as it permits communication between the various networked components as described herein.

The remote computers are divided up into two categories for purposes of simplifying the description. The first category is generally marked as PB_{N}; at least one of these remote computers is at the location of each print buyer. The second category is generally denoted as P_{N}; at least one of these remote computers is at the location of each printer. Both the print buyers and the printers use the remote computers at their respective locations to access the server. The print buyers may connect to the server to access the templates to create a print request, access any quotes from a printer that result from a print request, or place a print order with a printer that provided a quote. Additional features and functionality may be further added to the system for access by the print buyers. The printers may connect to the server to access the print requests placed by the print buyers and place a quote on the print requests, modify its quotes, or accept an order from a print buyer for a print job. Additional features and functionality may also be added to the system for access by the printers.

A plurality of templates 16 are programmed and stored on the server 12. The templates include a plurality of data fields and mapping instructions associated with the data fields. Each data field represents a print feature that is generally available for printed materials. Each template, depending upon how each is programmed, will not typically include a data field for the entire spectrum of print features as many print buyers do not need the entire set of features. Each template may therefore be as simple or as complex as required by the type of print jobs the print buyers will be using it to define. Thus, each template can be tailored to the needs of one or several print buyers, thereby eliminating options that may be confusing to or simply not needed by the print buyer.

The mapping instructions included with each template convert the format of the information entered into the data fields into the standardized print request format. The standardized format is, in essence, a common language that may be used to describe a print job, one that may be used in all stages of the print process. As such, the preferred standardized format is one that is widely adopted and used throughout the print industry. By implementing a standardized format for the print requests, the print specifications are consistent in the presentation of print jobs to the printers, thus resulting in greater consistency in the printed result. Further, by careful implementation of a standardized format, the print request may be used by the printers as is to organize and run the print jobs. The preferred standardized format is the Job Definition Format (JDF), the specification of which is controlled and maintained by the International Cooperation for Integration of Processes in Prepress, Press and Postpress (referred to as “CIP4”). Release 1.1, revision A of the JDF, the disclosure of which is incorporated herein by reference, is freely distributed and may be obtained by writing CIP4, c/o Lenz & Staehelin Aktiengesellschaft, Bleicherweg 58, 8002 Zurich, Switzerland, or by accessing http://www.cip4.org/ over the Internet. The JDF format uses the Extensible Markup Language (XML) to describe the print request information, including its structure and the interrelationships between the informational components.

The print job information entered into the template by the print buyer may be stored on the server for later use either by the print buyer or by the printer. When stored on the server, the information is preferably stored in the standardized print request format to facilitate later use.

The templates are generally programmed by an individual having significant knowledge of the printing needs of print buyers. Such an individual is referred to herein as the “expert user” or “print administrator”. The knowledge and experience of the expert user is important in programming the templates because the templates are preferably programmed to collect only the information required to perform a print job and dispense with the collection of information that is meaningless to the printing process, not needed for the print job, or unclear in terms of defining the print job. Therefore, the expert user makes the determination prior to the print request being made regarding the information that is needed and that which is not. The expert user is therefore improving the quality of the information submitted in a print request without ever having to review the actual information submitted. Further, this initial quality control step applies to all print buyers using a particular template, thus potentially saving significant amounts of time for the expert, the print buyer, and the printer during the print buying process.

The actual template programming that the expert user does may be performed locally at the server or from any remote computer coupled to the network, so long as the expert user has the proper authorization levels to access the server remotely. Further, if the programming is done at a remote computer, that computer should include the software needed for programming the templates. In the preferred embodiment, the outward appearance of the template is programmed in an Internet friendly language such as the Hypertext Markup Language (HTML), with the underlying mapping instructions, described in further detail below, formed using a more robust programming or text manipulation language such as C++, Java, or PERL. Those skilled in the art will recognize that a template design application that presents to the expert user a standard interface for creating templates may be desirable. Such a template design application would have the advantage of allowing an expert user who is not a computer programmer to create templates without requiring any knowledge of the underlying programming code.

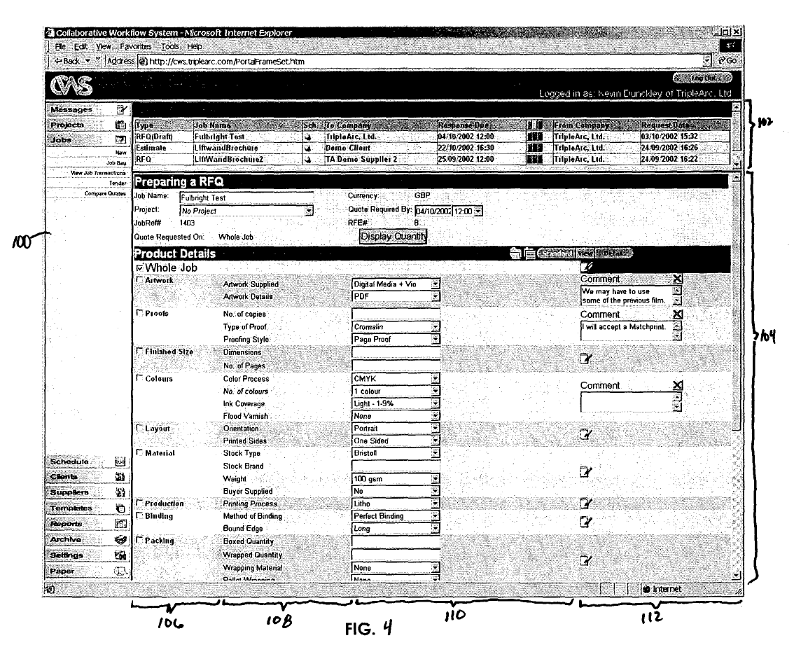

A print buyer accessing a template sees the data fields included with the template. FIG. 4 illustrates a sample template as would be viewed by a print buyer. Upon accessing the template, the print buyer enters the information specified by each data field. The print job is fully described when the print buyer has entered information in all the data fields, at which point the mapping instructions are activated to convert the entered information from the format as presented in the template to a print request in the standardized format. The print request thus also fully describes the print job. Optionally, the mapping instructions associated with the template may be programmed to insert a default value into the print specification for any data fields left blank by the print buyer.

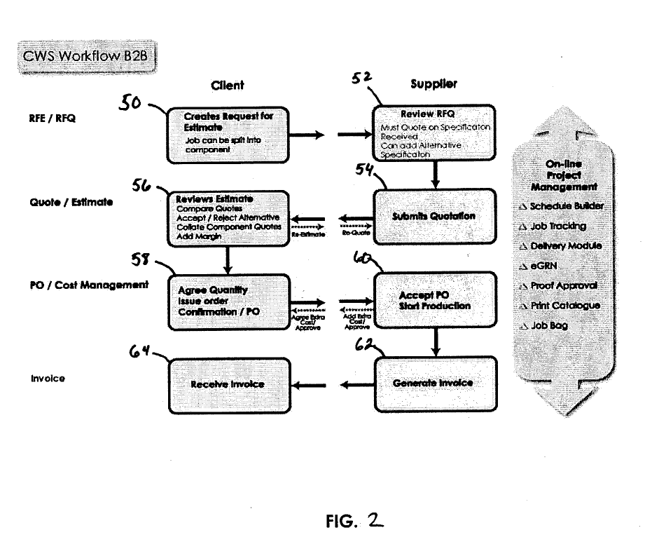

FIG. 2 illustrates a collaborative workflow system (CWS) that uses the previously described system in a business to business (B2B) environment. This CWS is one implementation of the above system, and those skilled in the art will recognize that many variations of the CWS described herein are possible to achieve the same objectives. The CWS facilitates the management of print projects from initiation of the project by the print buyer through assembly of the print specification, quotation by the printer, sending of a purchase order by the print buyer, and final invoicing of the completed print job. The entire process is preferably carried out in a user friendly manner using the Internet so that the parties involved may easily collaborate on the print job.

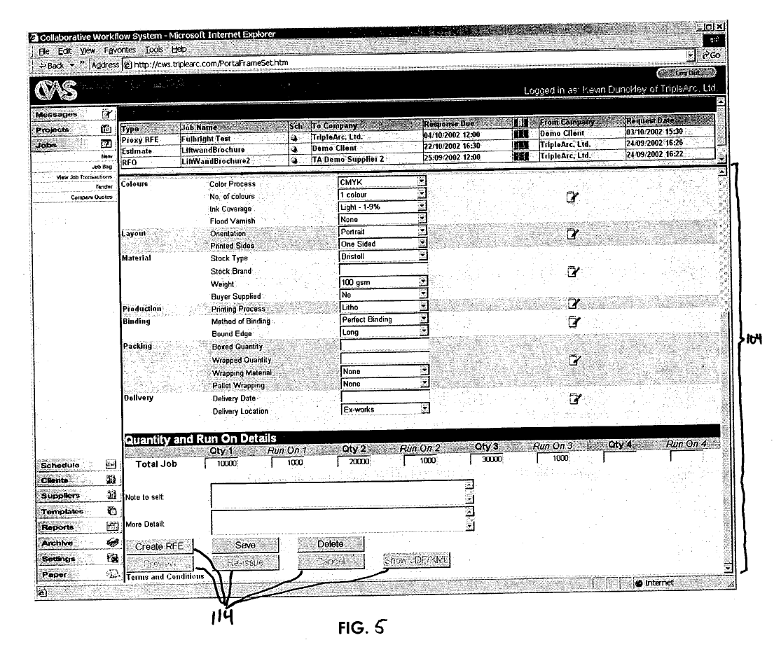

The print buyer (also referred to as the “client”) initiates the collaborative process by accessing a template (box 50) to create a print request in the standardized format. Preferably, an expert user familiar with the print buyer's printing needs has either directed the print buyer to the proper template for the particular print job or limited the print buyer's access to one or more templates that are appropriate for the print buyer's needs. Sample templates as viewed by the print buyer in the standard view are illustrated in FIGS. 4 and 5.

In FIG. 4, right side column 100 of the standard view, the print buyer is given the option of several categories to choose from, each category presenting different functions to the print buyer for management of the print job. By selecting the category marked “Jobs”, the print buyer can begin the process for a new print job or access information related to an already established print job. The current jobs and any newly created job are listed in an upper area 102 near the top of the standard view. By selecting one of the jobs listed in the upper area 102, the print buyer is given access to the template related to that print job. For new jobs, the print buyer is given the option, if one has been made available to the print buyer by the expert user, of accessing particular templates, as selected by the expert user, for the current print job.

The lower area 104 of the standard view presents the print buyer with more detailed job information, including the job name, the project name, if any, and the date by which a quote from a printer is required. The data fields of the template in use are also displayed in the lower area 104. The data fields viewed by the print buyer are limited to the data fields chosen by the expert user when designing the template. The lower area 104 is broken up into four columns for ease of display. The first column 106 lists the sub-categories into which the data fields divided. The second column 108 lists a field descriptor for each data field. The third column 110 lists the data entry fields where the print buyer enters the information relating to the print job. The fourth column 112 is a comment area that the print buyer may use to insert an expanded description relating to the particular data field. FIG. 5 illustrates a continuation of the lower area 104 of the template shown in FIG. 4. The lower area 104 portion illustrated in FIG. 5 shows the data fields into which the print buyer may enter quantities for the print job, run on details, and additional notes. Function buttons are included which enable the print buyer to send a request for an estimate to a printer, save, delete, cancel, preview, or re-issue the print request. A function button is also included which enables the print buyer to view the print request in the standardized format.

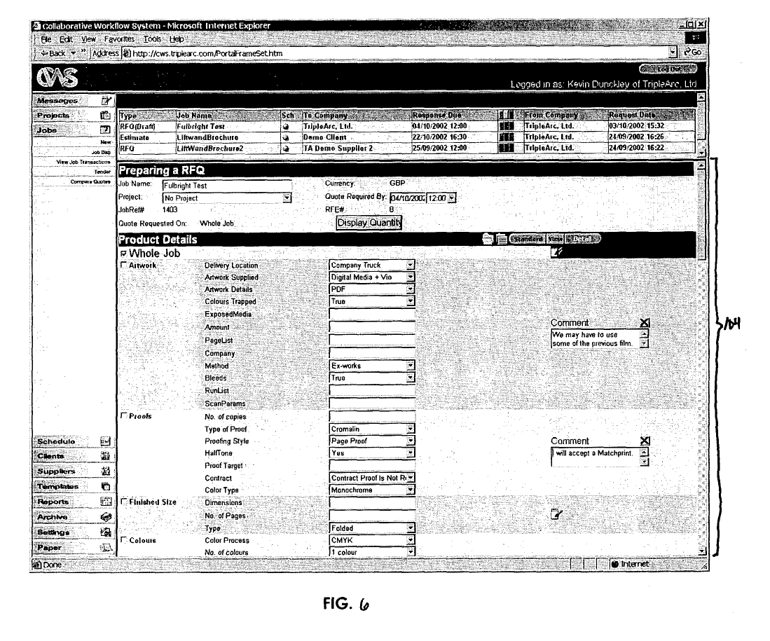

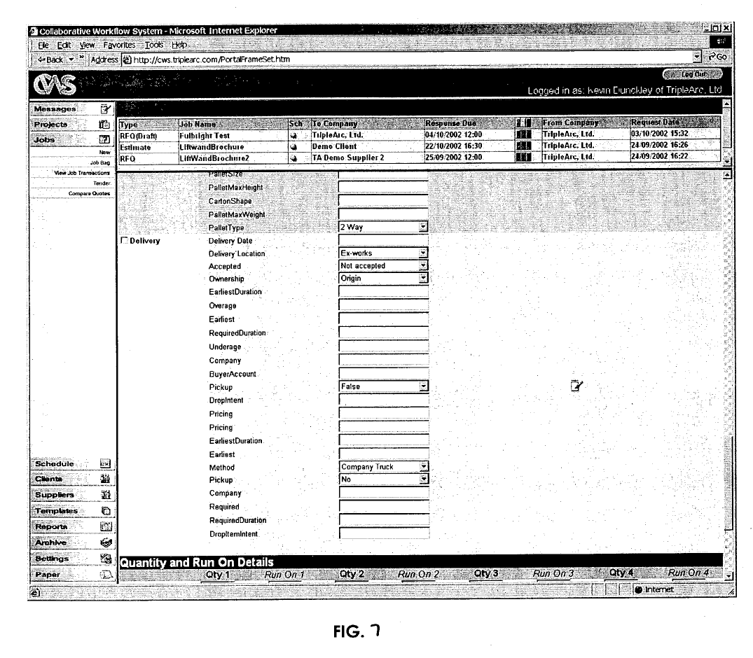

FIGS. 6 and 7 represent the detailed view of the same job illustrated by FIGS. 4 and 5. This detailed view is the view that may be seen by an expert user. The print buyer is prevented from accessing the detailed view. In the detailed view, unlike in the standard view, the lower area 104 lists all the data fields, thus enabling the expert user to change any and all aspects of the print job.

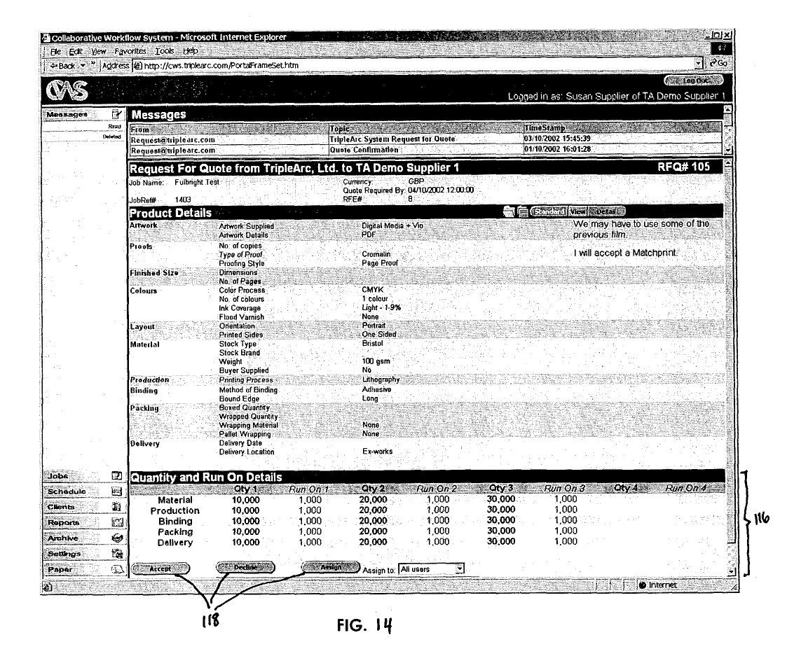

Returning to FIG. 2, once the print buyer has completed the template, the print request is sent to one or more printers (referred to as the “suppliers”). FIG. 14 illustrates the print request as received by the printer. The lower portion 116 of the print request includes function buttons 118 with which the printers may accept or decline the request for a quote. The printers review the print request (Box 52) and prepare their quotations (Box 54) for accepted print requests. The quotations are sent to the print buyer who reviews them (Box 56). The quotations and print requests may be sent back and forth between the print buyer and the printers multiple times as they are refined to more accurately meet the needs of the print buyer. The system preferably is capable of presenting quotes from multiple printers in a manner which clearly highlights the differences between the quotes. Once the print buyer determines that the proposed print specification meets its needs and settles on a supplier and its respective quote (Box 58), then the print buyer may utilize the system to send a purchase order to the printer chosen to do the work. The printer has the option to accept the purchase order (Box 60) if the terms are agreeable, or reject it and make a counter proposal to the print buyer. The purchase agreement may also undergo several iterations and refinement before the parties agree on terms. Once the print job is completed, or at times defined in the terms of an agreement, the printer may invoice the print buyer (Box 62) using the system. The print buyer receives the invoice electronically (Box 64). At all stages of the interaction between the print buyer and the printers, the system preferably automatically provides electronically transmitted updates to the parties at appropriate times or when changes are made to the print request, quotations, and purchase orders.

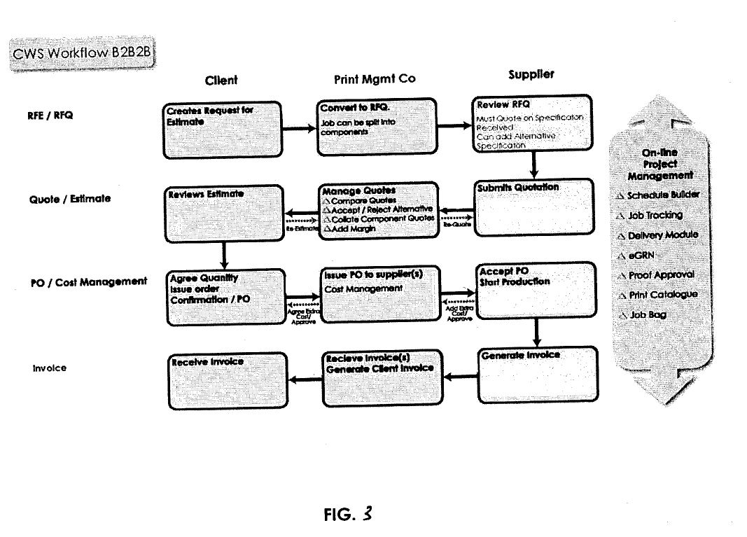

FIG. 3 illustrates a collaborative workflow system (CWS) that includes a print management company as an intermediary between the print buyer and the printer. This type of business environment is often referred to as business to business to business, or B2B2B. As the intermediary, the print management company acts as a proxy for the print buyer, acting with the authority and upon the approval of the print buyer. The print management company is given additional options, such as the option to mark up the price quotes sent by the printer. The print management company would also have access to the standard view of the template, thus enabling it to change the print request as needed based on input from both the printer and the print buyer. Alternatively, if the print management company is classified as an expert user, then it will have access to the detailed view of the template.

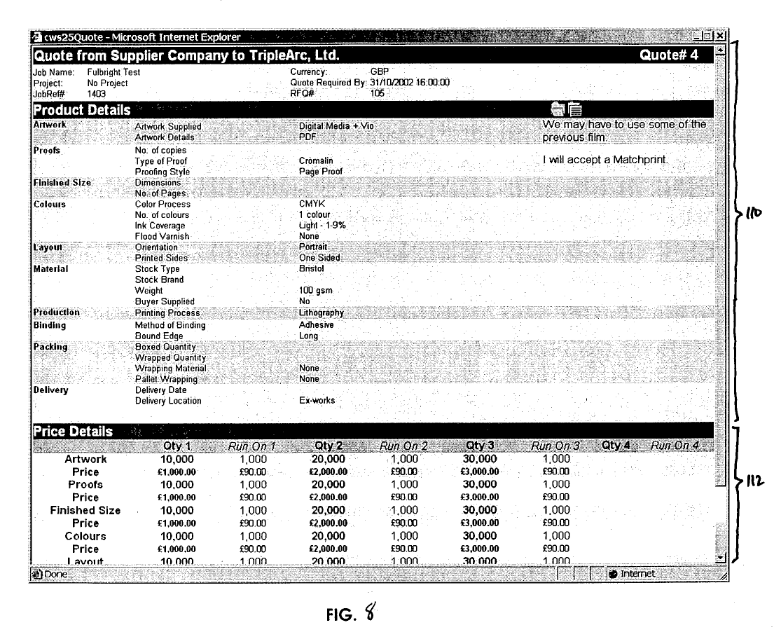

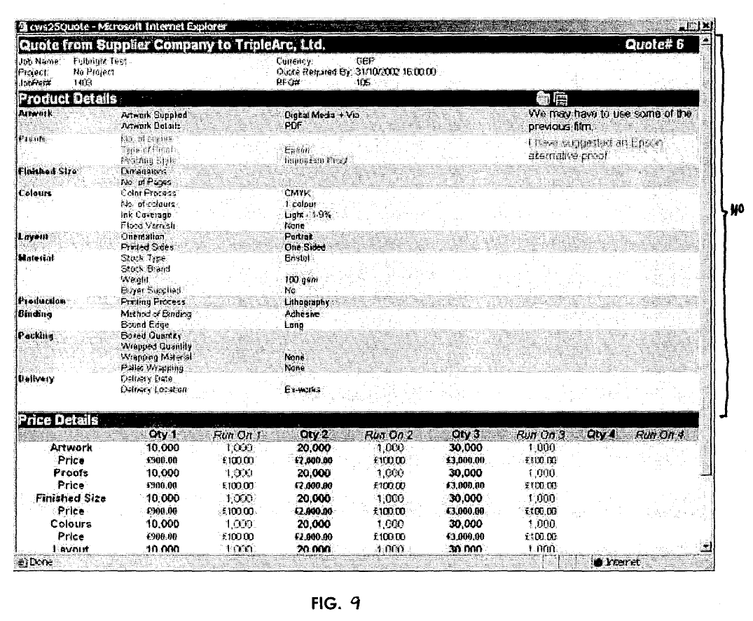

When a printer receives a print request from a print buyer, the printer has the option to accept or refuse to provide a quote. Preferably, the printer is required to provide a quote based on the print request as submitted. FIG. 8 illustrates a quote provided to a print buyer based on the originally submitted print request. The quote includes an upper area 110 that lists the print specification as entered by the print buyer and a lower area 112 that lists the price details as provided by the printer. Once the printer has submitted a quote on the originally submitted print request, the printer has the additional option of modifying the print request and submitting an additional quote. FIG. 9 illustrates a modified quote as submitted by the printer. In the modified quote, the modified portion of the print specification is differentiated from the unmodified portions of the print request to alert the print buyer to the changes made.

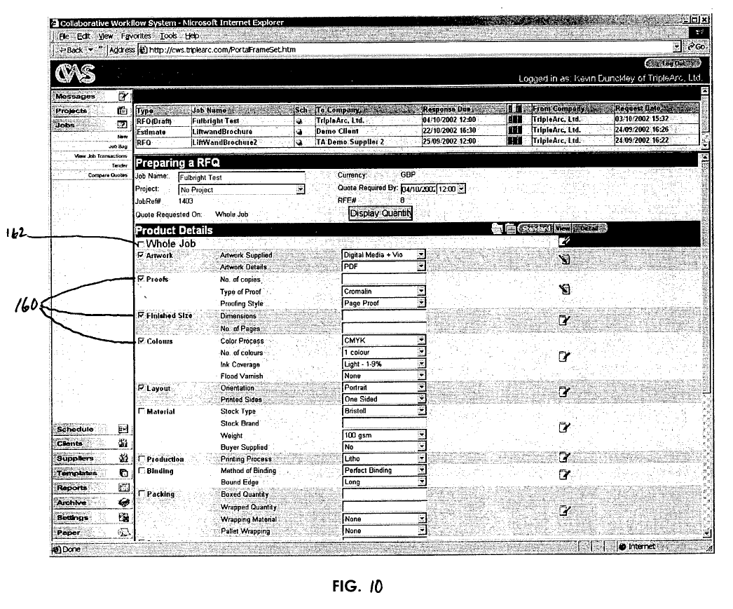

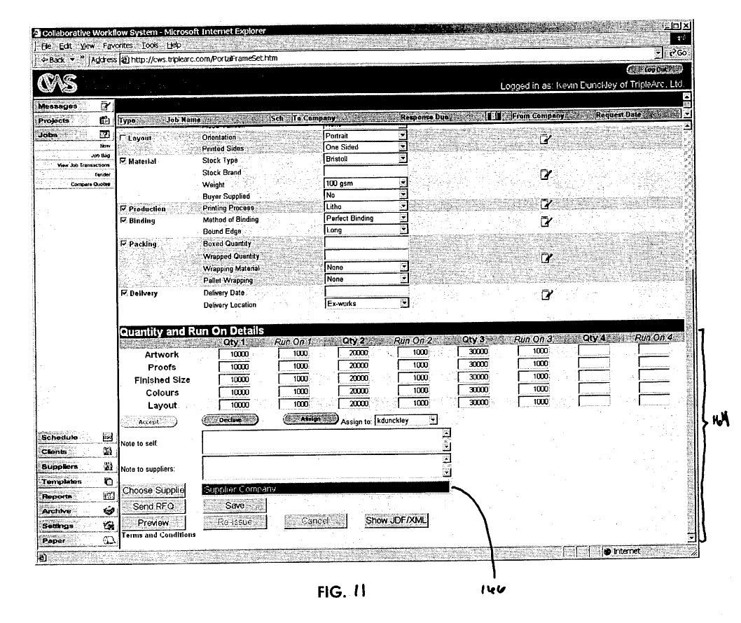

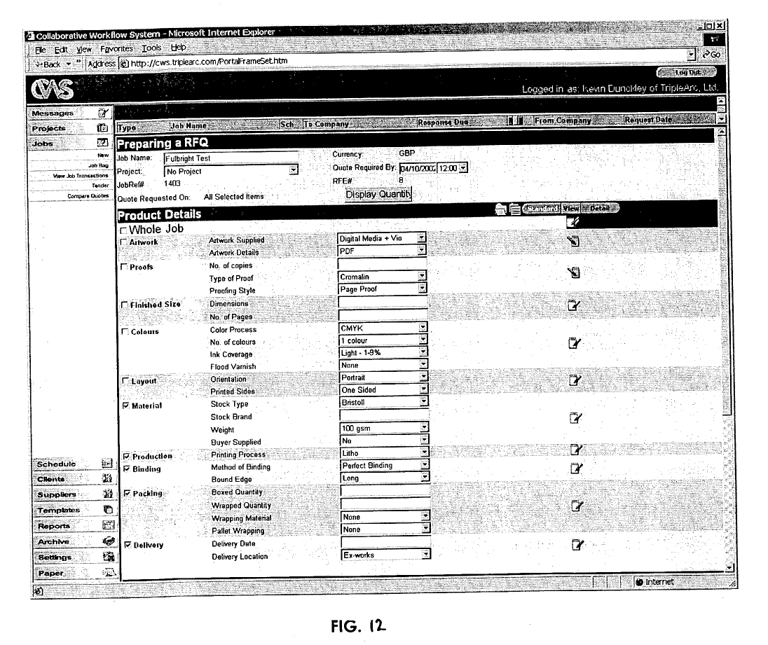

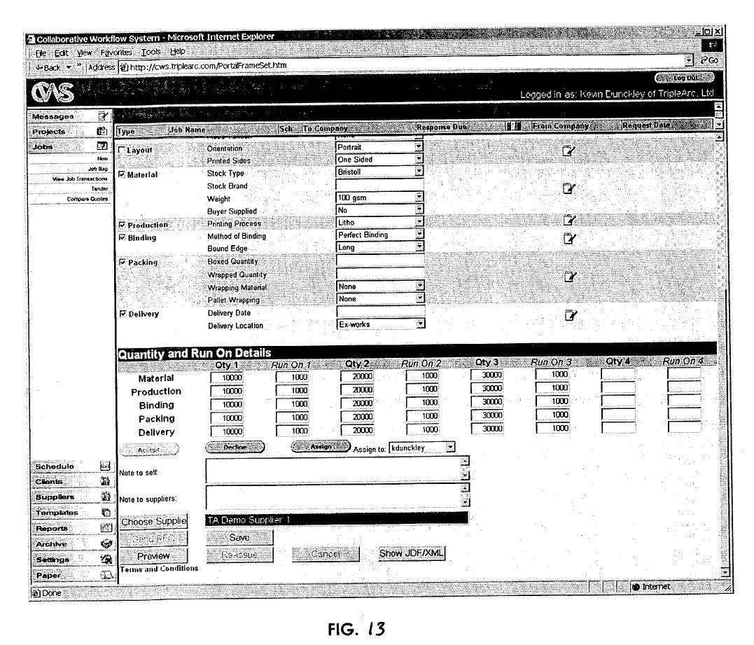

The print buyer also preferably has the option of splitting the print job between multiple printers. FIGS. 10-13 illustrate how a template is used to split the print job. FIGS. 10 and 11 illustrate upper and lower portions of the same template. Checkboxes 160 are provided for each sub-category of the data fields. A single checkbox 162 is also included for the print buyer to send the whole print request to the chosen printers. Using the checkboxes 160, the print buyer selects a subset of the subcategories that are to be sent to a first printer. In the lower portion 164 of the template in FIG. 11, a data field 166 is provided for the print buyer to select a first set of printers to send the subset to for a quote. FIGS. 12 and 13 illustrate the same template shown in FIGS. 10 and 11, but with a different subset of subcategories selected to be sent to a second set of printers for a quote.

Thus, a system and method of converting print jobs from one or more print buyers into print requests having a standardized format is disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A method of converting print jobs from one or more print buyers into standardized print requests comprising:
programming one or more templates, each template including a plurality of data fields and mapping instructions associated with the data fields, wherein each data field represents a print feature that is available for printed materials;
storing the templates on a server coupled to a network, wherein the templates are accessible using remote computers coupled to the network;
providing each print buyer access to at least one of the templates using one of the remote computers;
presenting each print buyer with the available data fields in the accessed template, each print buyer entering specified information into the data fields, wherein the specified information describes print features of a print job from each print buyer, respectively; and
converting the format of the specified information entered by each print buyer into a print request having a standardized format using the mapping instructions associated with the accessed template.

2. The method of claim 1, further comprising
storing the print request on the server; and
providing at least one printer access to the stored print request using one of the remote computers.

3. The method of claim 2, wherein the at least one printer provides a quote to the print buyer based on the print request.

4. The method of claim 3, further comprising
storing the quote on the server; and
providing the print buyer access to the stored quote using one of the remote computers.

5. The method of claim 4, wherein the print buyer obtains quotes from a plurality of printers based on the print request, the method further comprising preparing a comparison of the quotes and providing the print buyer access to the comparison using one of the remote computers.

6. The method of claim 4, wherein the print buyer places an order for the print job with the printer based upon the quote.

7. The method of claim 1, wherein if the print buyer leaves one or more of the data fields blank, then the mapping instructions direct a default value to be inserted into the standardized format for each blank data field.

8. The method of claim 1, wherein the at least one form the print buyer accesses is predetermined by a print administrator.

9. A system permitting one or more of a plurality of print buyers to submit standardized print requests to one or more of a plurality of printers comprising:
a server coupled to a network, the server storing one or more templates, each template including a plurality of data fields and mapping instructions associated with the data fields;
one or more remote computers coupled to the network, the templates stored on the server being accessible to each print buyer using the remote computers, wherein each print buyer is given access to one or more predetermined templates to enter specified information into the data fields of each predetermined template, the specified information being based upon a print job from each print buyer, respectively;
wherein the template causes the specified information to be transmitted to the server, the server converts the specified information for each print buyer, respectively, into a print request having a standardized format using the mapping instructions, and the server forwards the print request for each print buyer, respectively, to at least one of the plurality of printers.
